(19) United States
(12) Patent Application Publication
(10) Pub. No.: US 2024/0402130 A1
(43) Pub. Date: Dec. 5, 2024

(54) Ultrasound probe for inspection of a component at a temperature above 150°C and associated inspection method

(71) Applicant: FRAMATOME, COURBEVOIE (FR)

(72) Inventor: Jean-François SAILLANT, CHALON SUR SAONE (FR)

(21) Appl. No.: 18/699,706

(22) PCT Filed: Oct. 10, 2022
(86) PCT No.: PCT/EP2022/078143

§ 371 Date: Apr. 9, 2024

(30) Foreign Application Priority Data
Oct. 11, 2021 (FR) FR2110736

(51) Int. Cl. G01N 29/04; G01N 29/24

(52) U.S. Cl. CPC G01N 29/04; G01N 29/2437; G01N 2291/023; G01N 2291/0289; G01N 2291/101; G01N 2291/267

(57) ABSTRACT

An ultrasound probe for inspecting a component at a temperature above 150° C. includes a shoe that makes contact with the component and an ultrasonic transducer. The transducer includes a probe body defining an internal volume having a body length, the probe body further defining an aperture and a disc of piezoelectric material placed in the aperture, the disc having a front side making contact with the shoe, the disc having an acoustic impedance which includes between 7 MRayl and 25 MRayl and a Curie temperature above 250° C. The transducer also includes a damper fastened to the back side of the disc and extending from the back side into the internal volume for a damper length smaller than the body length.

### CROSS-REFERENCE TO RELATED APPLICATIONS

This application is the U.S. National Phase of PCT Appl. No. PCT/EP2022/078143 filed Oct. 10, 2022, which claims priority to FR 21 10736, filed Oct. 11, 2021, the entire disclosures of which are incorporated by reference herein.

### TECHNICAL FIELD

The present disclosure relates to an ultrasound probe for inspecting a component at a temperature above 150° C.

The present disclosure further relates to a method for inspecting the component using such probe.

### BACKGROUND

The present disclosure applies in particular to the non-destructive testing of components, in particular to the inspection of weld beads on such components.

### SUMMARY

Such components are e.g. nuclear reactor components such as a steam generator, a vessel or a primary conduit.

When replacing such a nuclear reactor component, it is necessary to carry out the welds on site. The production of the welds involves the implementation of restrictive means such as preheating the components to a temperature above 150° C. or local nitrogen inerting.

Conventionally, once the weld has been made, the structure is cooled and then inspected by an ultrasound non-destructive inspection method. If there are defects in the weld, it is then necessary to warm up the component before repairing the weld. The above involves mobilizing operational teams on site until the weld is declared to be compliant.

There is thus a need to be able to inspect the weld more quickly in order to save time during the replacement operation and thereby be able to restart the nuclear reactor more quickly.

However, known probes which can withstand a high temperature do not have sufficient acoustic performance to correctly inspect a weld.

On the other hand, known probes with good acoustic properties cannot withstand temperatures above 150° C. for extended periods of time. Indeed, the materials forming the shoe degrade at such temperatures, or the behavior thereof with respect to the ultrasound beam is considerably modified when the temperature increases.

In such context, the present disclosure aims to propose an ultrasound probe for the inspection of a component having good performance, continuously, at temperatures above 150° C. and thereby leading to significant time saving during maintenance operations.

To this end, the present disclosure relates to an ultrasound probe for inspecting a component at a temperature above 150° C., the probe extending along a main axis and comprising:
a shoe suitable for being brought into contact with the component to be inspected, and
an ultrasonic transducer attached to the shoe and configured to emit an ultrasound beam towards the shoe, the transducer including:
   a probe body defining an internal volume having a body length along the main axis, the probe body further defining an aperture towards the internal volume;
   a disk of piezoelectric material arranged in the aperture, the disk having a front side and a back side, the front side being configured to be in contact with the shoe, the disk having an acoustic impedance comprised between 7 MRayl and 25 MRayl and a Curie temperature greater than 250° C.;
   a damper attached to the back side of the disk and extending from the back side into the internal volume along the main axis over a damper length shorter than the body length.

Thereby, the probe according to the present disclosure is suitable for performing an inspection of the equipment at a temperature above 150° C. by means of the disk of piezoelectric material with low acoustic impedance and having a high upper Curie temperature. Such a probe serves to carry out the ultrasonic inspection of a weld bead progressively as the weld bead is filled, whereas the structure is still preheated, in a nitrogen atmosphere. Thereby, it is possible to repair a weld defect as soon as possible and thus to save considerable time on the replacement site as well as to considerably reduce uncertainties.

The probe can comprise one or a plurality of the following features, taken individually or according to any technically possible combination:
the damper comprises silicone and particles dispersed in the silicone;
each particle has a transverse dimension comprised between 10 μm and 250 μm;
the probe body comprises a ring arranged in the aperture, the ring being sealed to the disk and to the damper, the ring extending over a height comprised between 1 mm and 3 mm along the main axis, a part of the damper protruding out of the ring into the internal volume;
the shoe is made of polybenzimidazole;
the shoe comprises an entry surface in contact with the disk of the transducer and an exit surface suitable for being brought into direct contact with the component to be inspected, the entry surface and the exit surface forming an angle greater than 10° with each other;
the disk and the shoe are in direct contact, the probe having no acoustic matching layer arranged between the disk and the shoe; and
the probe comprises an electrical connector arranged in the transducer and configured to supply electricity to the disk.

The present disclosure further relates to a method for inspecting a component at a temperature above 150° C. by means of at least one probe as defined hereinabove, the method comprising at least the following steps:
bringing the shoe into contact with the component to be inspected;
emission of an ultrasound beam toward the shoe by the transducer, the beam being at least partially transmitted by the shoe towards the component.

Advantageously, the component comprising a weld bead which is being produced, the method further comprising, providing two probes according to any of the preceding claims and the arrangement of each of the probes on both sides of the weld bead being produced.

### BRIEF SUMMARY OF THE DRAWINGS

The present disclosure will be better understood upon reading the following description, given only as an example and making reference to the enclosed drawings, wherein:

FIG. 1 is a schematic side representation of an ultrasound probe according to the present disclosure, arranged on a component to be inspected and comprising an ultrasonic transducer and a shoe;

FIG. 2 is a section view of the ultrasonic transducer shown in FIG. 1; and

FIG. 3 is a schematic side representation of two probes according to the present disclosure on both sided of a weld bead to be inspected.

### DETAILED DESCRIPTION

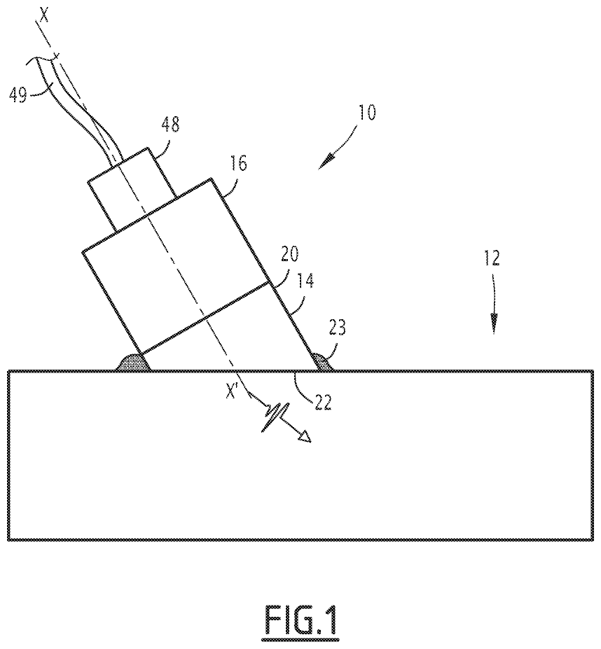

An ultrasound probe 10 is shown in FIG. 1.

The probe 10 is intended for ultrasonic inspection of components 12, in particular metallic components, such as e.g. nuclear reactor components. The probe 10 serves to detect defects in the components, and in particular in the weld beads. The defects are e.g. cavities, cracks or wetting defects. The components inspected are e.g. stainless steel, ferritic steel, Inconel, etc.

As can be seen in the figures, the probe 10 extends along a main axis X-X′.

The probe 10 comprises a shoe 14 and an ultrasonic transducer 16.

The shoe 14 and the transducer 16 are advantageously screwed together.

The shoe 14 and the transducer 16 are acoustically coupled to each other by means of a thin layer of liquid or gel resistant to high temperature.

In a variant, the shoe 14 and the transducer 16 are bound together by means of a thin layer of high temperature epoxy resin.

The shoe 14 is suitable for being brought into contact with the component 12 to be inspected.

The shoe 14 is advantageously made of polybenzimidazole.

Such class of polymers is particularly suitable for producing the shoe 14. Indeed, such materials are particularly resistant to high temperatures, up to 150° C. and even up to 427° C. Same do not degrade at 150° C. and even up to 427° C. Moreover, the attenuation of the ultrasound beam increases only slightly with temperature in said class of materials.

As can be seen on FIG. 1, the shoe 14 comprises an entry surface 20 and an exit surface 22.

The exit surface 22 is suitable for being in direct contact with the component 12.

The exit surface 22 of the shoe and the component 12 are brought into contact with each other by means of a thin layer 23 of coupling liquid or gel resistant to high temperature.

Each entry surface 20 is in contact with the ultrasonic transducer 16.

As can be seen in FIG. 1, the entry surface 20 and the exit surface 22 form an angle with each other greater than 10°, advantageously greater than 20°.

The entry 20 and exit 22 surfaces are arranged so that the ultrasound beam emitted by the ultrasonic transducer 16 penetrates the shoe 14 via the entry surface 20 and leaves the shoe 14 via the exit surface 22.

The transducer 16 is configured to emit an ultrasound beam towards the shoe 14.

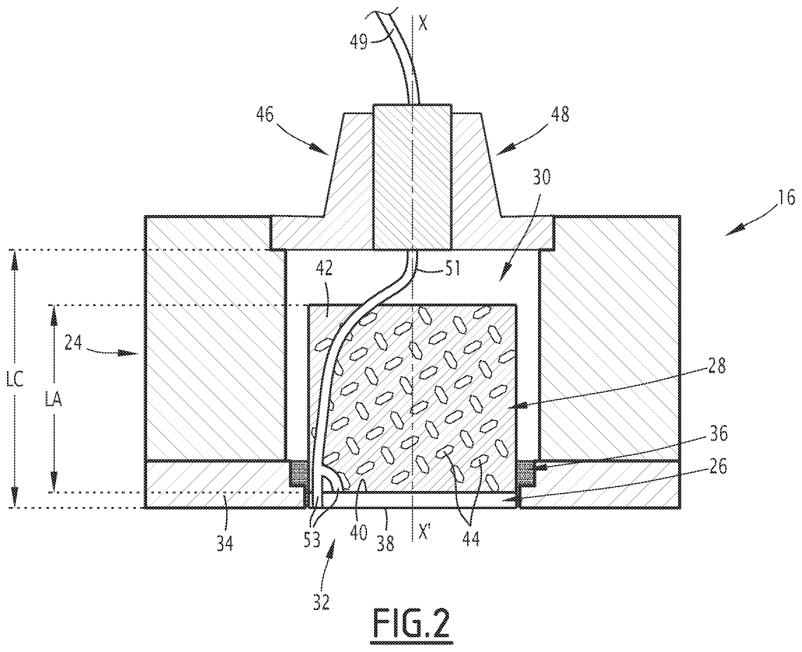

With reference to FIG. 2, the transducer 16 comprises a probe body 24, a disk 26 and a damper 28.

The probe body 24 comprises external walls, in particular metal walls. The probe body 24 has a substantially parallelepipedal shape. In a variant, the probe body 24 has a shape, e.g. cylindrical.

The probe body 24 defines an internal volume 30 having a body length LC along the main axis X-X′. The probe body 24 defines an aperture 32 toward the internal volume 30.

The probe body 24 advantageously comprises a ring 34 arranged in the aperture 32 and apt to be in contact with the shoe 14.

The ring 34 is sealed to the disk 26 and to the damper 28 via a seal 36. The seal 36 advantageously extends over a height comprised between 1 mm and 3 mm along the main axis X-X′, for a diameter of the disk 26 comprised between 3 mm and 30 mm.

The disk 26 is arranged in the aperture 32.

The disk 26 is made of a piezoelectric material. The disk 26 is configured to act as an ultrasonic emitter and to transmit ultrasonic waves towards the shoe 14. The disk 26 is a transducer which can generate and pick up ultrasounds. Same can thereby be used as an ultrasound transmitter or receiver.

The disk 26 has an acoustic impedance comprised between 7 MRayl and 25 MRayl, preferentially between 10 MRayl and 25 MRayl.

The acoustic impedance of the disk 26 is obtained by multiplying the density of the piezoelectric material forming the disk by the speed of sound propagation thereof. The impedance of a piezoelectric ceramic varies slightly depending on the temperature. However, the impedance remains low at 150° C., in particular less than 25 MRayl.

The acoustic impedance of a medium for an acoustic wave characterizes the resistance of the medium to the passage of the wave. It is recalled that 1 Rayl is equal to 1 Pa·s/m.

The disk 26 has a Curie temperature greater than 250° C.

The Curie temperature of a ferroelectric material is the temperature at which the material loses the remanent polarization thereof.

The disk 26 consists e.g. of a composite of PZT (lead zirconium titanate) and air.

The disk 26 has a front side 38 and a back side 40.

The front side 38 is configured to be in contact with the shoe 14. More particularly, the disk 26 and the shoe 14 are in direct contact.

Thereby, the probe 10 has no acoustic matching layer arranged between the disk 26 and the shoe 14, unlike conventional transducers. The stresses generated by a matching layer are such that same would bulge the piezoelectric disk 26 and would prevent a plane contact with the shoe 14 on the front side 38. In the present disclosure, the disk 26 made of piezoelectric material with low acoustic impedance serves to prevent such an acoustic matching at the front side 38.

As can be seen in FIG. 2, the damper 28 is attached to the back side 40 of the disk 26.

The damper 28 extends from the back side 40 into the internal volume 30 along the main axis X-X′ over a damper length LA shorter than the body length LC.

The damper 28 is partially sealed via the ring 34. Thereby, a part of the damper 28 protrudes freely out of the ring 34 into the internal volume 30. Since the damper 28 expands considerably, the partial sealing of the damper 28 with the probe body 24 prevents the risk that the bulging of the damper 28 leads to the explosion of the piezoelectric disk 26.

The damper 28 comprises silicone 42 and particles 44 dispersed in silicone 42. The particles 44 serve to diffuse the wave sent toward the rear of the probe 10 by the disk 26.

Each particle 44 is composed in particular of tungsten or alumina.

Each particle 44 has a transverse dimension comprised between 10 μm and 250 μm.

The damper 28 has an expansion coefficient approximately one hundred times higher than the expansion coefficient of the disk 26.

With reference to FIG. 2, the transducer 16 further comprises a rear cover 46 and an electrical connector 48.

The rear cover 46 is attached to the face of the probe body 24 opposite the aperture 32.

The electrical connector 48 is arranged in the rear cover 46. The electrical connector 48 is connected via an electrical cable 49 to an electronic control station for ultrasonic non-destructive testing (NDT) (not shown) and is thereby configured to transmit the electrical signals transmitted and received at the disk 26 via a transmission line 51. The transmission line is a coaxial cable which can withstand temperatures above 250° C.

The disk 26 includes an electrode 53 on each face 38, 40. One of the electrodes 53 is connected to ground and the other to the core of the coaxial cable. The electrode 53 on the side of the front side 38 rises on the lateral edge of the disk 26 in order to make possible, a return of the electrode 53 and the brazing of a wire from the back side 40 of the disk 26.

The electrical connection between the two electrodes 53 of the disk 26 and the coaxial cable is made by brazing in one or a plurality of points having a melting point greater than 250° C. Such repetition serves to make the probe reliable in the event of a break in one of the connections.

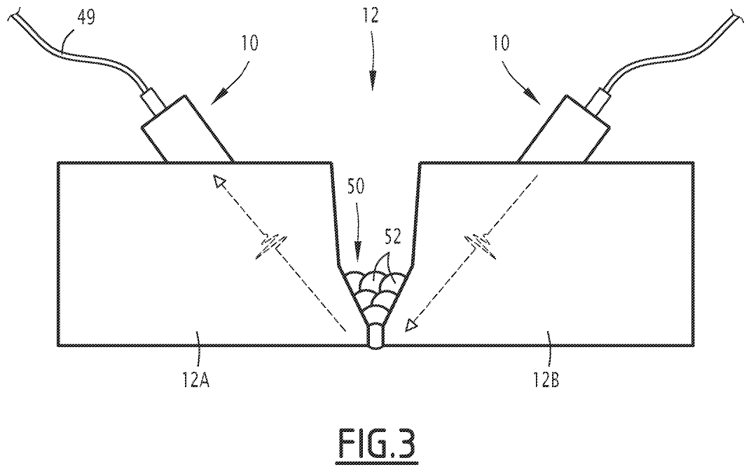

A method for inspecting a component 12 according to the present disclosure by means of such a probe 10 will henceforth be explained, with reference to FIG. 3.

The component 12 is e.g. a nuclear reactor component.

Before performing the welding, the component 12 is heated to a temperature above 150° C.

In the example shown herein, two probes 10 are used to check the integrity of a weld bead 50 being produced. The weld bead 50 serves to rigidly attach two parts 12A, 12B of the component 12 to be inspected. The weld bead 50 fills a groove provided between the two parts 12A, 12B. The weld bead is produced in a plurality of passes, a layer 52 of filler material being deposited in the groove at each pass. The layers 52 are arranged one on top of the other.

As can be seen in FIG. 3, the two probes 10 are arranged on both sides of the weld bead 50. A first probe 10 is thereby arranged on the first part 12A of the component 12 and a second probe 10 is arranged on the second part 12B of the component 12.

To carry out the inspection of the weld bead 50, the shoe 14 of each probe 10 is placed against the external surface of the component 12, at a distance from the weld bead 50 to be inspected. The distance is chosen so that the transmitted ultrasound beam is directed toward the zone to be inspected. Because the angle between the transmitted ultrasound beam and the normal to the surface is relatively constant and independent of the temperature of the component 12 at the time of testing, it is easy to determine the distance enabling the transmitted beam to be directed onto the weld bead 50 to be inspected.

Then, the transducer 16 is activated and emits an ultrasound beam towards the shoe 14. The incident ultrasound beam penetrates the shoe 14 via the entry surface 20, propagates inside the shoe 14 and exits via the exit surface 22. The beam then splits into a transmitted beam and a reflected beam. The transmitted beam penetrates into the component 12.

After striking the weld bead 50, the ultrasound beam is reflected and the echo thereof returns to the probe 10, as illustrated in FIG. 3. The echo is recorded and interpreted.

Thereby, the probe 10 according to the present disclosure serves to inspect a component at a temperature above 150° C., by means of the design thereof based on a choice of suitable materials and on an architecture leading to the reduction of thermomechanical stresses at the different interfaces.

It is then possible to carry out the ultrasonic inspection of the weld bead 50 progressively as the weld bead 50 is filled while the component 12 is preheated, in a nitrogen atmosphere.

Thereby, it is possible to repair a weld defect as soon as possible and thus to save considerable time on the replacement site as well as to considerably reduce uncertainties.

What is claimed is:

1-10. (canceled)

11. An ultrasound probe for inspecting a component at a temperature above 150° C., the probe extending along a major axis and comprising:
a shoe suitable for being brought into contact with the component to be inspected; and
an ultrasonic transducer attached to the shoe and configured to emit an ultrasonic beam towards the shoe, the transducer including:
a probe body defining an internal volume having a body length along the main axis, the probe body further defining an aperture towards the internal volume;
a disk of piezoelectric material arranged in the aperture, the disk having a front side and a back side, the front side being configured to be in contact with the shoe, the disk having an acoustic impedance comprised between 7 MRayl and 25 MRayl and a Curie temperature greater than 250° C.; and
a damper attached to the back side of the disk and extending from the back side into the internal volume along the main axis over a damper length shorter than the body length.

12. The probe according to claim 11, wherein the damper comprises silicone and particles dispersed in the silicone.

13. The probe according to claim 12, wherein each particle has a transverse dimension comprised between 10 μm and 250 μm.

14. The probe according to claim 11, wherein the probe body comprises a ring arranged in the aperture, the ring being sealed to the disk and the damper via a seal, the seal extending over a height comprised between 1 mm and 3 mm along the main axis, a part of the damper protruding out of the ring into the internal volume.

15. The probe according to any of claim 11, wherein the shoe is made of polybenzimidazole.

16. The probe according to claim 11, wherein the shoe comprises an entry surface in contact with the disk of the transducer and an exit surface suitable for being brought in direct contact with the component to be inspected, the entry surface and the exit surface forming an angle greater than 10° with each other.

17. The probe according to claim 11, wherein the disk and the shoe are in direct contact, the probe having no acoustic matching layer arranged between the disk and the shoe.

18. The probe according to claim 11, wherein the probe comprises an electrical connector arranged in the transducer and configured to supply electricity to the disk.

19. A method for inspecting a component at a temperature above 150° C. using at least one probe according to claim 11, the method comprising at least the following steps:
bringing the shoe into contact with the component to be inspected; and
emission, by the transducer, of an ultrasound beam toward the shoe, the beam being at least partially transmitted by the shoe to the component.

20. The inspection method according to claim 19, the component comprising a weld bead which is being produced, the method further comprising providing two probes according to any of the preceding claims and the arrangement of each of the probes on both sides of the weld bead being produced.
